(19) United States
(12) Patent Application Publication
(10) Pub. No.: US 2012/0130999 A1
(43) Pub. Date: May 24, 2012

(54) Method and Apparatus for Searching Electronic Documents

(76) Inventors: Jian Ming Jin, Bejing (CN); Sheng Wen Yang, Beijing (CN); Yuhong Xiong, Mountain View, CA (US); Xiao Liang Hao, Shanghai (CN); De Miao Lin, Beijing (CN)

(21) Appl. No.: 13/258,473

(22) PCT Filed: Aug. 24, 2009
(86) PCT No.: PCT/CN2009/073446

§ 371 Date: Dec. 19, 2011

(51) Int. Cl. G06F 17/30

(52) U.S. Cl. 707/723; 707/758; 707/E17.008; 707/E17.014

(57) ABSTRACT

Disclosed is a method and apparatus for searching electronic documents. The 5 apparatus comprises first and second data repositories storing tags for representing content of an electronic document. The first data repository is adapted to store structured tags and their respective association with an electronic document, a structured tag comprising information representing its relationship to at least one other tag. The second data repository is adapted to 10 store free tags and their respective association with an electronic document, a free tag not comprising information representing its relationship to any other tags. Electronic documents can be searched by accessing the first and second data repositories, and matching a search query with one or more tags in the first and second data repositories. For each matched tag, an electronic document 15 associated with the tag can then be retrieved and a ranking for the electronic document determined based on attributes of the document and its associated tag.

Conventional search engines for searching electronic documents, such as web and company intranet pages, accept a search query from a user, and generate a list of search results containing one or more terms of the search query. The user typically views one or two of the results and then discards the results as needed.

For example, an employee of a company in China may wish to search the company intranet to find all human resource policies valid in China. The employee can achieve some results by querying “HR China Policy”. But there are some problems with this query. For example, the following related documents cannot be retrieved: (i) documents containing “Human Resources” instead of “HR”; and (ii) documents describing worldwide applicable policies not containing the term “China”.

It is known to associate data classification tags or keyword identifiers with an electronic document so as to represent content of the document. Such classification tags or identifiers have been shown to assist in identifying relevant documents when searching.

Furthermore, it is known to organize data classification tags in a hierarchical structure so as to represent one or more relationships between such tags. However, it is difficult to define a well organized hierarchical structure of data classification tags, especially for a general field of information. Accordingly, the definition and building of an organized tag architecture is typically restricted to experts.

### BRIEF DESCRIPTION OF THE EMBODIMENTS

Embodiments are described in more detail and by way of non-limiting examples with reference to the accompanying drawings, wherein

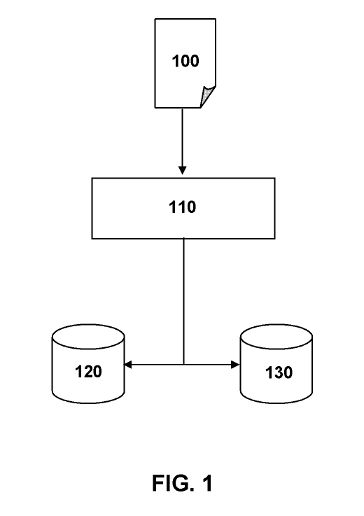

FIG. 1 shows apparatus for searching electronic documents in accordance with an embodiment;

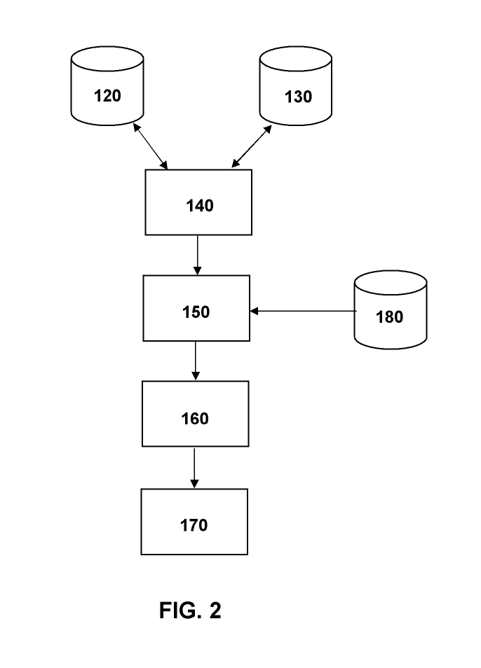

FIG. 2 shows a system for searching electronic documents in accordance with an embodiment;

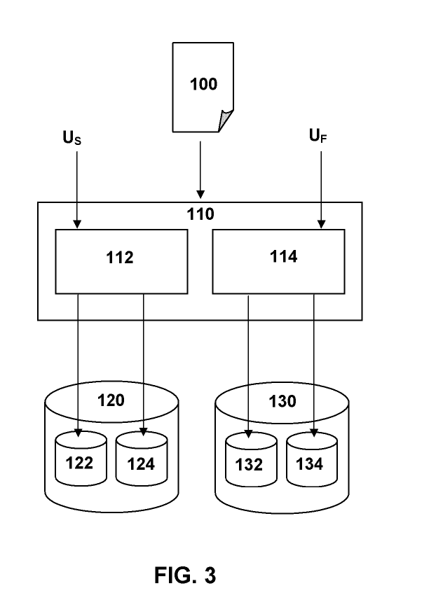

FIG. 3 apparatus for searching electronic documents in accordance with another embodiment;

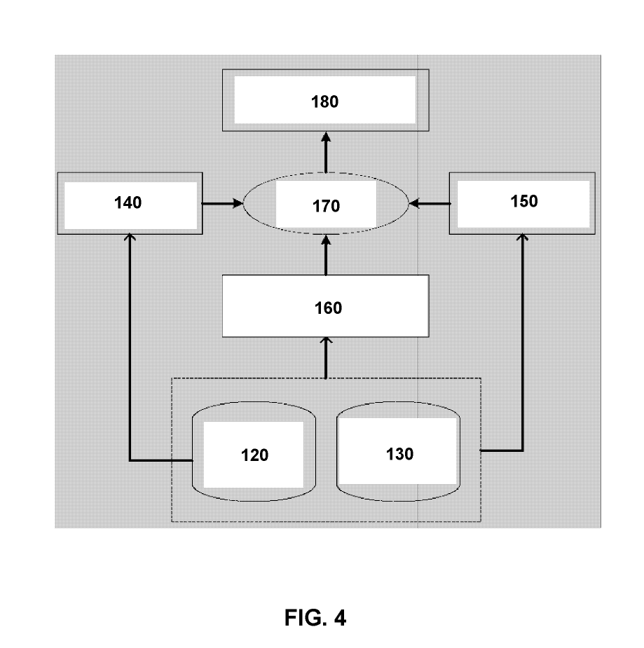

FIG. 4 illustrates an exemplary use of the first and second data repositories of FIG. 1;

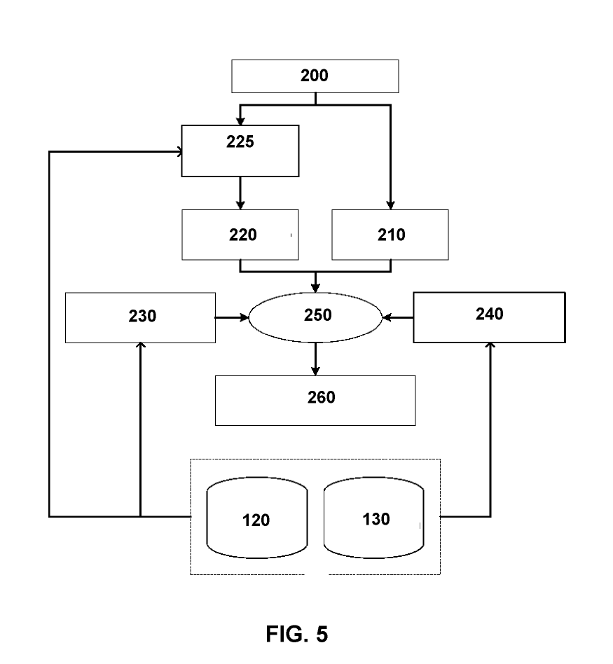

FIG. 5 illustrates another exemplary use of the first and second data repositories of FIG. 1; and

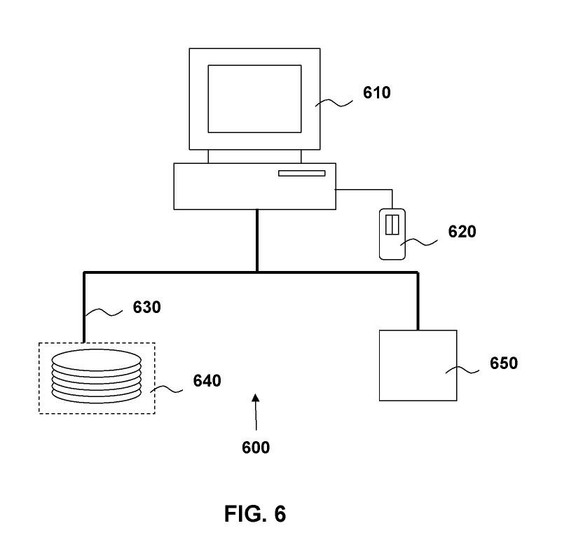

FIG. 6 shows a data processing system in accordance with an embodiment.

### DETAILED DESCRIPTION OF THE DRAWINGS

It should be understood that the Figures are merely schematic and are not drawn to scale. It should also be understood that the same reference numerals are used throughout the Figures to indicate the same or similar parts.

Hereinafter, a data classification tag representing the content of the document is referred to as a tag. Thus, a tag can be a keyword identifier which is associated with an electronic document so as to represent content of the document.

Referring to FIG. 1, proposed is apparatus for searching electronic documents comprising: a document tagging module 110 adapted to a generate a tag representing content of an electronic document 100 and to associate the tag with the electronic document 100; a first data repository 120 adapted to store structured tags and their respective association with an electronic document 100, a structured tag comprising information representing its relationship to at least one other tag; and a second data repository 130 adapted to store free tags and their respective association with an electronic document 100, a free tag not comprising information representing its relationship to any other tags.

Turning now to FIG. 2, also proposed is a system for searching electronic documents. The system comprises a processing unit 140 adapted to access a first data repository 120 storing structured tags and their respective association with an electronic document, to access a second data repository 130 storing free tags and their respective association with an electronic document, and to match a search query with one or more tags in the first and second data repositories. The system also comprises a matching unit 150, a ranking unit 160, and a result filter 170. The matching unit 150 is adapted to, for each matched tag, access a document database 180 and to retrieve an electronic document associated with the tag. The ranking unit 160 is adapted to determine a ranking for each retrieved document based on attributes of the document and its associated tag. The filter 170 then selects one or more documents using the determined rankings from the ranking unit 160. Thus, documents identified as being potentially relevant in view of a search query can be ranked or clustered according to tag and document information. For example documents associated with one or more preferred tags may be ranked first, since more focus on finding documents relating to one or more aspects/terms of a query may be preferred.

Embodiments can combine tag information and content information for ranking search results. By using structured tags, semantic meanings and search query context can be accounted for to provide improved searching accuracy. Also, the use of free tags enables the implementation and searching of a simple and flexible tagging architecture in conjunction with a document database. Both user-defined and machine-generated tags may be catered for, thus enabling the use of flexible and accurate document data repositories and searching.

Turning now to FIG. 3, another embodiment is illustrated wherein the tagging module is adapted to generate both structured tags and free tags. Thus, the tagging module 110 may associate a plurality of different type of tags with a single document.

Specifically, the tagging module 110 comprises a structured tagging module 112 which is adapted to generate structured tags and a free tagging module 114 which is adapted to generate free tags. The structured tags generated are organized as hierarchical trees, directed graphs, or other structures so as to comprise information representing their relationship to at least one other tag. In this way, semantic meanings can be associated to the structured tags.

The structured tagging module 112 is adapted to provide the structured tags to the first data repository 120, whereas the free tagging module 114 is adapted to provide the free tags to the second data repository 130.

The structured tagging module 112 and the free tagging module 114 are each adapted to analyze an electronic document, to generate one or more tags based on the analysis, and to associate the one or more tags with the electronic document. Several methods can be used for such automatically generated tags.

Here, methods based on term frequency, part-of-speech and topic modeling are used to automatically generate free tags.

A term frequency based method extracts words that appear in a document with a high frequency and identifies the extracted words as free tags.

A part-of-speech based method extracts phrases which meet a predefined part-of-speech combination rules and identifies the extracted phrases as free tags.

A topic modeling based method learns the probability distribution of words on topics from a corpus in advance, recognizes the talked topics of a document, and returns words with maximal probabilities on the talked topics as free tags.

Rule or classification based methods can be used to generate structured tags automatically. A rule-based method assigns a structured tag to a document according to predefined rules. A classification-based method assigns a structured tag to a document by document classification models which can be trained by machine learning methods, such as SVM (Support Vector Machine), ANN (Artificial Neutral Network), Bayes, etc.

Also, each of the structured tagging module 112 and the free tagging module 114 is adapted to generate a structured tag and free tag, respectively, in accordance with a user defined input. Specifically, a user-defined input U_{S} for the generation of a structured tag can be provided to the structured tagging module 112 via a suitable user interface (not shown). Also, a user-defined input U_{F} for the generation of a free tag can be provided to the free tagging module 114 via another user interface (not shown). Moreover, a user is able to add, remove, edit, approve or disapprove a tag via the user-defined inputs U_{S} and U_{F}.

It will be appreciated that the structured 112 and free 114 tagging modules are each adapted to generate user-defined tags in addition to automatically/machine generated tags. To maintain this distinction between user-defined tags and automatically/machine generate tags, these two types of tags are stored separately in each of the first 120 and second 130 data repositories.

Here, the structured tags are stored in two separate sub-repositories 122 and 124 of the first data repository 120, wherein the machine-generated structured tags are stored in a first sub-repository 122 of the first data repository 120, and wherein the user-defined structured tags are stored in a second sub-repository 124 of the first data repository 120. Similarly, the free tags are stored in two separate sub-repositories 132 and 134 of the second data repository 130, wherein the machine-generated free tags are stored in a first sub-repository 132 of the second data repository 130, and wherein the user-defined free tags are stored in a second sub-repository 134 of the second data repository 130.

Referring to FIG. 4, an exemplary use of the first and second data repositories 120 and 130 for document searching will now be described.

As shown in FIG. 4, there are two separate approaches that can be used for document searching: tag organized navigation 140 and tag cloud navigation 150. The process of tag organized navigation 140 uses the structured tags of the first data repository, while the tag cloud navigation 150 process uses both the structured tags of the first data repository 120 and the free tags of the second data repository 130. Irrelevant of which approach is used, documents labeled with the tags matching a search query are retrieved and ranked by a document retrieval process 160.

The ranking process uses a degree of relevance value based on attributes of the tags and documents. For example, one may define a relevance value R_{T}(p,t) of a document p and associated tag t, wherein the value of R_{T}(p,t) is defined by equation 1 as follows:

R_{T}(p,t)=W_{N}*N_{U}(p,t)+(1−W_{N})*N_{M}(p,t) (1),

where N_{U}(p, t) is the number of users who associated document p with a tag t, N_{M}(p, t) is the number of machines that associated document p with tag t, and W_{N} is a factor that controls the weights of N_{U}(p, t) and N_{M}(p, t).

The relevance value R_{T}(p) of a document p may then be defined as the sum of all relevance values for the document p, as represented by equation 2:

R_{T}(p)=SUM(R_{T}(p,t)) (2).

Combining the results from either the tag organized navigation 140 process or the tag cloud navigation 150 process with the result of the ranking process 160, one or more of the highest ranked documents are selected in a filtering process 170 and presented to a user in output process 180

Referring to FIG. 5, another exemplary use of the first and second data repositories 120 and 130 for document searching will now be described.

Firstly, a search query is received and processed in a search input process 200. The search query includes both content search information and tag search information. Consequently, two separate search processes are performed: a content search 210 and a tag search 220.

The content search 210 retrieves all documents whose contents match the input search query. The tag searching 220 retrieves all documents whose tags match the input search query. For tags belong to an organized tag architecture (i.e. structured tags), a tag expansion process 225 is first executed before the tag searching process 220 so as to expand the tags to be searched.

Next, all retrieved documents are clustered 230 and ranked 240 according to the tag information and content information.

The tag based search result ranking process 240 combines a predetermined ranking result (such as PageRank result) with tag information. For example, one may define a rank value of R(p) of a document p according to equation 3 as follows:

R(p)=W_{S}*R_{T}(p)+(1−Wₛ)*R_{O}(p) (3),

wherein R_{T}(p) is the relevance value between tags associated to p and the query terms, R_{O}(p) is a known ranking value of document p, W_{S} is a factor that controls the weights of R_{T}(p) and R_{O}(p).

The results from clustering 230 and ranking 240 processes are combined and one or more of the highest ranked documents are selected in a result filtering process 250. Finally, the selected documents are presented to the user in output process 260.

Turning now to FIG. 6, a data processing system 600 in accordance with an embodiment is shown. A computer 610 has a processor (not shown) and a control terminal 620 such as a mouse and/or a keyboard, and has access to an electronic library or document database stored on a collection 640 of one or more storage devices, e.g. hard-disks or other suitable storage devices, and has access to a further data storage device 650, e.g. a RAM or ROM memory, a hard-disk, and so on, which comprises the computer program product implementing a method according to an embodiment. The processor of the computer 610 is suitable to execute the computer program product implementing a method in accordance with an embodiment. The computer 610 may access the collection 640 of one or more storage devices and/or the further data storage device 650 in any suitable manner, e.g. through a network 630, which may be an intranet, the Internet, a peer-to-peer network or any other suitable network. In an embodiment, the further data storage device 650 is integrated in the computer 610.

It will be appreciated that embodiments provide advantages which can be summarized as follows:

Embodiments combine the advantages of structured tag architectures and free tag architectures.

User contributed tags can used in conjunction with machine contributed tags. Sometimes, users may not be willing to define tags, so machine contributed tags can boost the tag results and prompt human users to add or modify existing tags.

Search results can be improved through the use of tag information/attributes. A data classification tag can be viewed as a kind of document content summarization tool or keyword identifier. Thus, ranking search results taking account of tag attributes improves has been shown to improve search result accuracy and quality.

It should be noted that the above-mentioned embodiments are illustrative, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. Embodiments can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. Apparatus for searching electronic documents comprising:
a document tagging module to a generate a tag representing content of an electronic document and to associate the tag with the electronic document;
a first data repository to store structured tags and their respective association with an electronic document, a structured tag comprising information representing its relationship to at least one other tag; and
a second data repository to store free tags and their respective association with an electronic document, a free tag not comprising information representing its relationship to any other tags.

2. The apparatus of claim 1, wherein the document tagging module comprises:
a first tagging unit to generate a structured tag and to associate the structured tag with an electronic document;
a second tagging unit to generate a free tag and to associate the free tag with an electronic document;

3. The apparatus of claim 1, wherein the document tagging module is to analyze an electronic document, to generate one or more structured tags or free tags based on the analysis, and to associate the one or more tags with the electronic document.

4. The apparatus of claim 1, wherein the document tagging module is to generate a user-defined structured tag or user-defined free tag according to a user's instructions, and to associate the user-defined tag with an electronic document.

5. A method of representing content of an electronic document, the method comprising:
generating a tag representing content of an electronic document:
associating the tag with the electronic document;
determining if the tag is either a structured tag or a free tag, wherein a structured tag comprises information representing its relationship to at least one other tag, and wherein a free tag does not comprises information representing its relationship to any other tags;
storing the tag and its association with an electronic document in either a first data repository or second data repository based on whether the tag is determined to be a structured tag or a free tag.

6. The method of claim 5, wherein the step of generating a tag comprises:
analyzing an electronic document;
generating a structured tags or free tag based on the analysis; and
associating the tag with the electronic document.

7. The method of claim 5, wherein the step of generating a tag comprises:
generating a user-defined structured tag or user-defined free tag according to user's instruction; and
associating the user-defined tag with an electronic document.

8. The method of claim 5, further comprising:
accessing a first data repository storing structured tags and their respective association with an electronic document, a structured tag comprising information representing its relationship to at least one other tag;
accessing a second data repository storing free tags and their respective association with an electronic document, a free tag not comprising information representing its relationship to any other tags;
matching a search query with one or more tags in the first and second data repositories;
for each matched tag, retrieving an electronic document associated with the tag;
determining a ranking for each retrieved document based on attributes of the document and its associated tag; and
selecting one or more documents using the determined rankings.

9. The method of claim 8, wherein the step of determining a ranking utilizes an algorithm considering an indicator of the reliability of the document or tag.

10. The method of claim 8, wherein the step of determining a ranking utilizes an algorithm taking account of whether a tag is machine generated or user-defined.

11. The method of claim 8, wherein the attributes of the document comprise a predetermined page rank value of the document.

12. The apparatus of claim 1, further comprising:
a first tag searching unit to access said first data repository storing structured tags and their respective association with an electronic document, a structured tag comprising information representing its relationship to at least one other tag;
a second tag searching unit to access said second data repository storing free tags and their respective association with an electronic document, a free tag not comprising information representing its relationship to any other tags;
a tag matching unit to match a search query with one or more tags in the first and second data repositories;
a document retrieval unit to, for each matched tag, retrieve an electronic document associated with the tag;
a ranking unit to determine a ranking for each retrieved document based on attributes of the document and its associated tag; and
a document selection unit to select one or more documents using the determined rankings.

13. A computer program product comprising a computer-readable data storage medium that is storing instructions arranged to, if executed on a computer, cause the computer to perform:
accessing a first repository storing structured tags representing content the electronic documents and their respective association with an electronic document, a structured tag comprising information representing its relationship to at least one other tag;
accessing a second data repository storing free tags and their respective association with an electronic document, a free tag not comprising information representing its relationship to any other tags;
matching a search query with one or more tags in the first and second data repositories;
for each matched tag, retrieving an electronic document associated with the tag;
determining a ranking for each retrieved document based on attributes of the document and its associated tag; and
selecting one or more documents using the determined rankings.

14-15. (canceled)

16. The computer program product of claim 13, further comprising instructions arranged to, if executed on a computer, cause the computer to perform:
generating a tag representing content of an electronic document:
associating the tag with the electronic document;
determining if the tag is either a structured tag or a free tag, wherein a structured tag comprises information representing its relationship to at least one other tag, and wherein a free tag does not comprises information representing its relationship to any other tags;
storing the tag and its association with an electronic document in either a first data repository or second data repository based on whether the tag is determined to be a structured tag or a free tag.

17. The computer program product of claim 13, wherein determining a ranking utilizes an algorithm considering an indicator of the reliability of the document or tag.

18. The computer program product of claim 13 wherein determining a ranking utilizes an algorithm taking account of whether a tag is machine generated or user-defined.

19. The computer program product of claim 13, wherein the attributes of the document comprise a predetermined page rank value of the document.
